(19) United States
(12) Patent Application Publication
(10) Pub. No.: US 2026/0178883 A1
(43) Pub. Date: Jun. 25, 2026

(54) METHODS AND SYSTEMS FOR PROCESSING DATA USING LARGE MULTIMODAL MODELS

(71) Applicant: Huawei Cloud Computing Technologies Co., Ltd., Guizhou (CN)

(72) Inventors: Gursimran SINGH, Delta (CA); Zhenan FAN, Vancouver (CA); Yifan HU, Burnaby (CA); Xinglu WANG, Burnaby (CA); Yong ZHANG, Burnaby (CA)

(21) Appl. No.: 19/000,264

(22) Filed: Dec. 23, 2024

(51) Int. Cl. G06N 3/0455; G06F 12/02

(52) U.S. Cl. CPC G06N 3/0455; G06F 12/023

(57) ABSTRACT

Methods and devices for processing multimodal data using a Large Multimedia Model. The method includes an encoding process to receive multimodal data, generate multimodal tokens, and store them in a cache; a prefill process to combine multimodal and text tokens, generate attention states and an initial output token, and store them in memory; and a decoding process to retrieve stored data, generate successive output tokens in an autoregressive manner, and produce an output response. A communication process facilitates independent operation of these processes by mapping memory blocks across graphics processing units, and thereby enables inter-process data transfer. The encoding, prefill, and decoding processes operate asynchronously, independently, and in parallel.

The present technology is generally related to Large Multimodal Models (LMMs), and more specifically, to methods and systems for optimizing inference pipelines in LMMs.

### BACKGROUND

In recent years, Large Language Models (LLMs) have demonstrated remarkable performance in tasks related to language understanding and reasoning. Traditionally, LLMs have been limited to processing text-based inputs. However, with the increasing demand to handle multimodal data—such as images, audio, and three-dimensional (3D) data—there has been a shift towards developing Large Multimodal Models (LMMs). LMMs extend the capabilities of LLMs, enabling interactions with data including images, sounds, and videos.

The architecture of LMMs typically includes three primary components: a text encoder, a vision encoder, and an LLM backbone. The text encoder processes textual inputs and converts them into embedding vectors or tokens. The vision encoder processes multimedia inputs, such as images, to generate visual tokens, using models such as Vision Transformers (ViTs). These textual and visual tokens are combined and processed by the LLM backbone, which uses a prefill process, where a key-value (KV) cache and an initial token are generated, and a decode process, where successive tokens are generated in an autoregressive manner.

One challenge associated with LMMs is the large number of tokens generated by vision encoders, particularly during the prefill stage, which can impact Service Level Objectives (SLOs) when models are used for real-time applications. Additionally, the resource demands for multimodal data encoding in LMMs are significant, consuming substantial memory and compute power.

Depending on the LMM, the resource demands may vary, with some models being encoding-heavy and others prefill-heavy. This variability complicates resource allocation and often results in contention, bottlenecks, and delays in the inference pipeline.

In light of these considerations, at least some techniques have been developed to address the challenges associated with managing resource allocation and reducing latency in LMM inference pipelines. These techniques include monolithic systems, which couple the encoding, prefill, and decode processes, leading to resource contention and limiting optimization across individual processes. Another approach involves partially disaggregated systems, where the decode process is separated from the encoding and prefill processes. While this provides some flexibility by enabling independent operation of the decode process, the coupling of encoding and prefill processes still restricts granularity in resource allocation and configuration, resulting in suboptimal performance.

Hence, despite these recent advancements, there is a need to develop systems and methods that enable disaggregation of the encoding, prefill, and decode processes.

### SUMMARY

Developers of the present technology have designed a method and a system that may tackle some of the challenges associated with processing data using LMMs. This method includes the disaggregation of encoding, prefill, and decode processes, based on which the system enables independent optimization and dynamic resource allocation for each process.

The present technology may have a variety of advantages. Some embodiments of the present technology may enable disaggregation of encoding, prefill, and decode processes and reduce resource contention by assigning dedicated resources to each process. Additionally, some embodiments of the present technology may improve key performance metrics of LMMs, including Request Throughput (RT), Time to First Token (TTFT), and Time Per Output Token (TPOT). Furthermore, the system may provide adaptability to varying application requirements, allowing tailored configurations for batch size, scheduling strategies, and parallelization for each process. Some embodiments of the present technology may also reduce memory requirements by purging unnecessary models from the respective step. For example, vision encoder is not needed during the encoding and decoding processes, and LLMs are not needed during the encoding process. Hence, some embodiments of the present technology may purge vision encoder and LLMs during the encoding process, and purge vision encoder during the decoding process, and thereby reduce memory requirements. Some embodiments of the present technology may also support the use of a Vision Encoding (VE) cache to store vision tokens and enable asynchronous data transfer by initializing independent VE caches for the encoding and prefill processes. Additionally, some embodiments of the present technology may implement a VE Block Manager for slot allocation and a VE Cache Puller for data transfer between the encoding and prefill processes, reducing latency and enabling optimal utilization of resources during the processing of vision tokens.

Some implementations of the present technology can be used by applications deploying LMMs, such as chatbots, automated content generation systems, image analysis systems, video analysis systems, three-dimensional (3D) data processing tasks etc.

In a first broad aspect of the present technology, there is provided a method for processing multimodal data using a Large Multimedia Model (LMM), the method comprising an encoding process including receiving multimodal data from an external source, generating multimodal tokens from the received multimodal data, and storing the generated multimodal tokens in a multimodal cache; a prefill process including retrieving the multimodal tokens stored in the multimodal cache, receiving text tokens from a text encoder, generating combined embeddings by combining the retrieved multimodal tokens and the received text tokens, generating attention states based on the combined multimodal tokens and text tokens, generating an initial output token, and storing the initial output token and the attention states in memory blocks; a decoding process including retrieving the initial output token and attention states stored in the memory blocks, generating successive output tokens in an autoregressive manner based on the retrieved initial output tokens and the retrieved attention states, and generating an output textual response based on the generated output tokens; a communication process including generating an address mapping for memory blocks across graphics processing units associated with the encoding process, the prefill process, and the decoding process, and enabling the encoding process, the prefill process, and the decoding process to access memory blocks associated with each other to support data transfer between the encoding process, the prefill process, and the decoding process; wherein the encoding process, the prefill process, and the decoding process operate independently during the processing of the multimodal data.

In some embodiments of the method, the encoding process, the prefill process, and the decoding process form an executing module of the method.

In some embodiments of the method, the encoding process, the prefill process, and the decoding process operate in parallel.

In some embodiments of the method, the encoding process, the prefill process, and the decoding process operate asynchronously.

In some embodiments of the method, the independent operation of the encoding process, the prefill process, and the decoding process includes independent optimal batching, parallelization, scheduling, and resource allocation.

In some embodiments of the method, the multimodal data includes vision data, audio data, or three-dimensional scenes.

In some embodiments of the method, the memory blocks used for storing the initial output token belong to a local central processing unit.

In some embodiments of the method, the memory blocks used for storing the attention states belong to a key-value cache of a graphics processing unit.

In some embodiments of the method, the encoding process, the prefill process, and the decoding process operate on a single physical system.

In some embodiments of the method, the encoding process, the prefill process, and the decoding process operate on separate servers connected over a network

In some embodiments of the method, the external source is a user or a system providing multimodal data for processing.

In some embodiments of the method, the attention states include keys and values, derived by a multi-head attention mechanism in transformer architectures, the keys representing linear projections of input embeddings indicative of contextual relationships, and the values representing corresponding projections that encode content information used by the multi-head attention mechanism.

In some embodiments of the method, the method further comprises a resource allocation process including receiving sample multimodal data comprising at least one of textual data and visual data from an external source; receiving at least one service level objective from an external source; determining a modality composition of the received sample multimodal data; determining computational characteristics of the LMM; and determining at least one of resource allocation parameters, batching parameters, scheduling parameters, and parallelization parameters for the encoding process, the prefill process, and the decoding process based on the determined modality composition, the determined computational characteristics, and the at least one service level objective.

In some embodiments of the method, the method further comprises a bootstrapping process including receiving at least one resource allocation parameter, at least one parallelization parameter, at least one batching parameter, and at least one scheduling parameter associated with the encoding process, the prefill process, and the decoding process; initializing the encoding process, the prefill process, and the decoding process based on the received parameters; allocating memory blocks for storing data temporarily, the data including multimodal tokens, text tokens, initial output token, and attention states; and establishing communication pathways between the encoding process, the prefill process, and the decoding process for transferring data between them.

In some embodiments of the method, the modality composition of the received sample multimodal data is indicative of the received sample multimodal data being image-heavy, text-heavy, or mixed.

In some embodiments of the method, the computational characteristics of the LMM are indicative of the LMM being Large Language Model (LLM)-heavy or non-textual heavy.

In some embodiments of the method, determining the resource allocation parameters includes determining assignments of graphics processing units for the encoding process, the prefill process, and the decoding process; memory block allocation sizes for caches used by the encoding process, the prefill process, and the decoding process; and batching sizes, scheduling strategies, and parallelization strategies for the encoding process, the prefill process, and the decoding process.

In some embodiments of the method, the at least one service level objective includes a minimum request throughput, a maximum allowable time to first output token, and a maximum allowable time per output token.

In some embodiments of the method, the memory blocks include a multimodal cache for storing multimodal tokens generated by the encoding process, memory blocks on a central processing unit (CPU) for storing the initial output token, and a key-value cache for storing the attention states generated by the prefill process.

In a second broad aspect of the present technology, there is provided an electronic device comprising a non-transitory computer-readable medium and a processor, the non-transitory computer-readable medium comprising instructions, which upon being executed by the processor, configure the processor to execute an encoding process including receiving multimodal data from an external source, generating multimodal tokens from the received multimodal data, and storing the generated multimodal tokens in a multimodal cache; a prefill process including retrieving the multimodal tokens stored in the multimodal cache, receiving text tokens from a text encoder, generating combined embeddings by combining the retrieved multimodal tokens and the received text tokens, generating attention states based on the combined multimodal tokens and text tokens, generating an initial output token, and storing the initial output token and the attention states in memory blocks; a decoding process including retrieving the initial output token and attention states stored in the memory blocks, generating successive output tokens in an autoregressive manner based on the retrieved initial output tokens and the retrieved attention states, and generating an output textual response based on the generated output tokens; a communication process including generating an address mapping for memory blocks across graphics processing units associated with the encoding process, the prefill process, and the decoding process, and enabling the encoding process, the prefill process, and the decoding process to access memory blocks associated with each other to support data transfer between the encoding process, the prefill process, and the decoding process; wherein the encoding process, the prefill process, and the decoding process operate independently during the processing of the multimodal data.

In some embodiments of the electronic device, the encoding process, the prefill process, and the decoding process form an executing module of the processor.

In some embodiments of the electronic device, the encoding process, the prefill process, and the decoding process operate in parallel.

In some embodiments of the electronic device, the encoding process, the prefill process, and the decoding process operate asynchronously.

In some embodiments of the electronic device, the independent operation of the encoding process, the prefill process, and the decoding process includes independent optimal batching, parallelization, scheduling, and resource allocation.

In some embodiments of the electronic device, the multimodal data includes vision data, audio data, or three-dimensional scenes.

In some embodiments of the electronic device, the memory blocks used for storing the initial output token belong to a local central processing unit.

In some embodiments of the electronic device, the memory blocks used for storing the attention states belong to a key-value cache of a graphics processing unit.

In some embodiments of the electronic device, the encoding process, the prefill process, and the decoding process operate on a single physical system.

In some embodiments of the electronic device, the encoding process, the prefill process, and the decoding process operate on separate servers connected over a network

In some embodiments of the electronic device, the external source is a user or a system providing multimodal data for processing.

In some embodiments of the electronic device, the attention states include keys and values, derived by a multi-head attention mechanism in transformer architectures, the keys representing linear projections of input embeddings indicative of contextual relationships, and the values representing corresponding projections that encode content information used by the multi-head attention mechanism.

In some embodiments of the electronic device, the processor further comprises a resource allocation process including receiving sample multimodal data comprising at least one of textual data and visual data from an external source; receiving at least one service level objective from an external source; determining a modality composition of the received sample multimodal data; determining computational characteristics of the LMM; and determining at least one of resource allocation parameters, batching parameters, scheduling parameters, and parallelization parameters for the encoding process, the prefill process, and the decoding process based on the determined modality composition, the determined computational characteristics, and the at least one service level objective.

In some embodiments of the electronic device, the processor further comprises a bootstrapping process including receiving at least one resource allocation parameter, at least one parallelization parameter, at least one batching parameter, and at least one scheduling parameter associated with the encoding process, the prefill process, and the decoding process; initializing the encoding process, the prefill process, and the decoding process based on the received parameters; allocating memory blocks for storing data temporarily, the data including multimodal tokens, text tokens, initial output token, and attention states; and establishing communication pathways between the encoding process, the prefill process, and the decoding process for transferring data between them.

In some embodiments of the electronic device, the modality composition of the received sample multimodal data is indicative of the received sample multimodal data being image-heavy, text-heavy, or mixed.

In some embodiments of the electronic device, the computational characteristics of the LMM are indicative of the LMM being Large Language Model (LLM)-heavy or non-textual heavy.

In some embodiments of the electronic device, determining the resource allocation parameters includes determining assignments of graphics processing units for the encoding process, the prefill process, and the decoding process; memory block allocation sizes for caches used by the encoding process, the prefill process, and the decoding process; and batching sizes, scheduling strategies, and parallelization strategies for the encoding process, the prefill process, and the decoding process.

In some embodiments of the electronic device, the at least one service level objective includes a minimum request throughput, a maximum allowable time to first output token, and a maximum allowable time per output token.

In some embodiments of the electronic device, the memory blocks include a multimodal cache for storing multimodal tokens generated by the encoding process, memory blocks on a central processing unit (CPU) for storing the initial output token, and a key-value cache for storing the attention states generated by the prefill process.

In the context of the present technology, “Large Multimodal Models (LMMs)” refers to computational models capable of processing multiple types of data, such as text, images, audio, or three-dimensional data, and generating outputs by combining information across these modalities.

In the context of the present technology, “Tokens” or “Embeddings” refer to numerical representations of input data, such as text or images, that capture features or patterns within the data.

In the context of the present technology, “Autoregression” refers to a method where each token is generated sequentially based on previously generated tokens.

In the context of the present technology, “Encoding process” refers to the operation where input data, such as text or images, is converted into tokens or embeddings.

In the context of the present technology, “Key” refers to a numerical representation derived from input tokens that encodes positional or contextual relationships within a dataset.

In the context of the present technology, “Value” refers to a numerical representation associated with a key that encodes content information for use in attention mechanisms.

In the context of the present technology, “Prefill process” refers to the operation where a key-value (KV) cache is generated based on a combination of input tokens, and an initial output token is generated to initialize the decoding process.

In the context of the present technology, “KV cache” refers to a memory structure that stores keys and values computed during the prefill process, which are used to generate successive tokens during the decoding process.

In the context of the present technology, “Decoding process” refers to the autoregressive operation that generates successive output tokens based on the initial output token and key-value pairs stored in the KV cache.

In the context of the present technology, “EPD disaggregated system” refers to a system in which the encoding (E), prefill (P), and decode (D) processes are separated into independent stages, allowing each process to operate on dedicated resources and enabling asynchronous execution and optimized resource allocation.

In the context of the present technology, “Request” refers to an input query or task submitted to the system for processing, which may include data such as text, images, or other multimodal inputs.

In the context of the present technology, “Attention mechanism” refers to a method used in neural networks to prioritize specific parts of input data, such as text or images, by assigning varying levels of importance to different elements.

In the context of the present technology, “Ray worker” refers a central processing unit (CPU)-based process that controls the workload execution on a GPU.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates an architecture of a typical vision-based LMM known in the art.

FIG. 3A illustrates a monolithic execution flow of an LMM known in the art.

FIG. 3B illustrates a partially disaggregated execution flow of an LMM known in the art.

FIG. 4 illustrates a fully disaggregated execution flow of an LMM, in accordance with at least some non-limiting embodiments of the present technology.

FIG. 5 illustrates an example scenario of a Model as a Service (MaaS) for LMMs, including resource allocation and Service Level Objective (SLO) criteria, in accordance with at least some non-limiting embodiments of the present technology.

FIG. 6 illustrates a request's data flow in an EPD disaggregated system, in accordance with at least some non-limiting embodiments of the present technology.

FIG. 7 illustrates a block diagram of the resource allocation module for an EPD disaggregated system, in accordance with at least some non-limiting embodiments of the present technology.

FIG. 8 illustrates the workflow and decision-making processes of the resource allocation module for an EPD disaggregated system, in accordance with at least some non-limiting embodiments of the present technology.

FIG. 9 illustrates a block diagram of the bootstrapping module for an EPD disaggregated system, in accordance with at least some non-limiting embodiments of the present technology.

FIG. 10 illustrates a block diagram of the execution module for an EPD disaggregated system, in accordance with at least some non-limiting embodiments of the present technology.

FIG. 11 illustrates the architecture of the execution module for an EPD disaggregated system, in accordance with at least some non-limiting embodiments of the present technology.

FIG. 12 is a scheme-block illustration of a method executed by a processor of the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

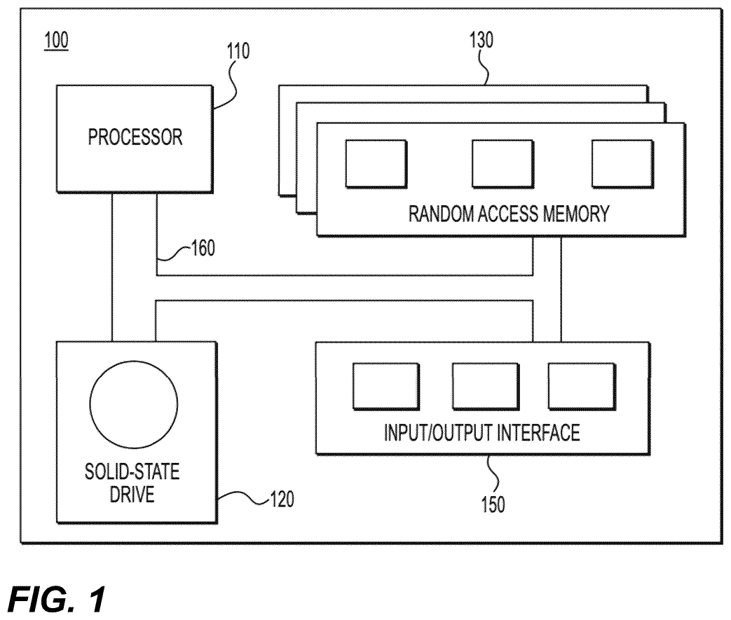

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, NvLink etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

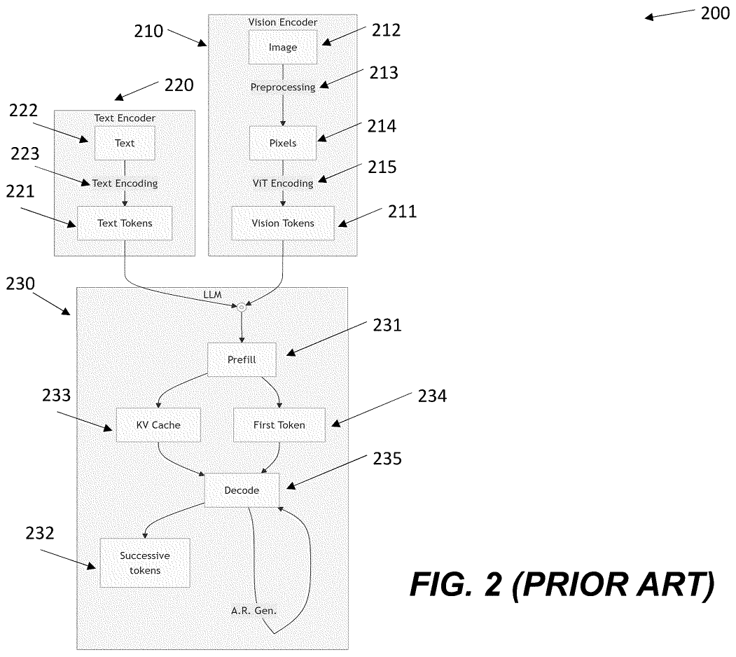

FIG. 2 illustrates an architecture 200 of a typical vision-based LMM known in the art.

The architecture 200 includes a vision encoder 210, a text encoder 220, and an LMM backbone 230. The vision encoder 210 receives multimodal inputs such as images 212. The text encoder 220 receives textual inputs 222. The vision encoder 210 processes the multimodal inputs through preprocessing operation 213 to generate pixels 214, which undergo Vision Transformer (ViT) encoding operation 215 to generate vision tokens 211. Depending on the type of modality, some embodiments of the present technology may use a different encoding operation. For example, in case of audio data, an audio encoder may be used to generate audio tokens as output. Similarly, the text encoder 220 processes the textual inputs 222 to generate text tokens 221 through a text encoding operation 223.

The vision tokens 211 and text tokens 221 are passed to the prefill stage 231 of the LMM backbone 230, where the initial Key-Value (KV) cache 233 and the first output token 234 are generated. Following the prefill stage 231, the architecture 200 enters the decode stage 235 of the LMM backbone 230, where successive tokens 232 are generated in an autoregressive manner.

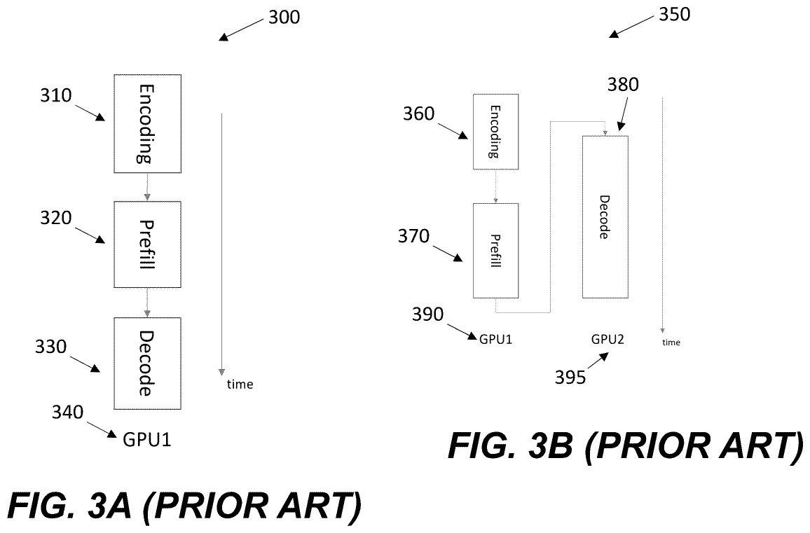

FIG. 3A illustrates a monolithic execution flow 300 of an LMM known in the art.

The monolithic execution flow 300 includes an encoding process 310, a prefill process 320, and a decode process 330, executed sequentially on the same graphics processing unit (GPU) resource 340. In the monolithic execution flow 300, the encoding process 310, prefill process 320, and decode process 330 are coupled and share the same computational resources.

In a monolithic execution flow, the system allocates GPU resources collectively for the encoding process 310, the prefill process 320, and the decode process 330. Parameters such as batch size, scheduling strategy, and parallelization strategy are determined considering the entire execution flow as a single unit.

Based on the determined parameters, a set of GPU resources is assigned by the system to process a batch of requests. During processing the batch of requests, the encoding process 310, the prefill process 320, and the decode process 330 operate sequentially on the same GPU resource 340, following a unified batching strategy.

Upon completing processing for a batch of requests, the system assigns the GPU resources to a subsequent batch of requests and repeats the workflow in a similar sequential manner.

The monolithic execution flow 300 may result in resource contention among the encoding, prefill and decoding processes since these processes are executed sequentially without the ability to allocate or optimize resources independently for each process. This limitation may introduce latency and bottlenecks, particularly in applications requiring real-time performance, and may also reduce throughput, may negatively affect TTFT and TPOT, limit image resolution, and restrict the number of images processed per request.

FIG. 3B illustrates a partially disaggregated execution flow 350 of an LMM known in the art.

The partially disaggregated execution flow 350 includes an encoding process 360, a prefill process 370, and a decode process 380. The encoding process 360 and the prefill process 370 are coupled and share computational resources on a first GPU resource 390, while the decode process 380 is disaggregated and executed independently on a second GPU resource 395.

In the partially disaggregated execution flow 350, the system allocates GPU resources jointly for the encoding and prefill processes (360 and 370 respectively) on GPU 390 and independently for the decode process 380 on GPU 395. Parameters such as batch size, scheduling strategy, and parallelization strategy are determined jointly for the encoding process 360 and prefill process 370, while the decode process 380 has its parameters configured independently.

Based on the determined parameters, a set of GPU resources is assigned by the system to process a batch of requests. The encoding process 360 and prefill process 370 operate sequentially on the same GPU resource 390, processing the batch of requests using a unified batching and scheduling strategy. Since the encoding process 360 and prefill process 370 share the same resources, their batching, parallelization, and scheduling configurations may be complicated to be adjusted independently.

Upon the completion of the prefill process 370, data, such as the key-value (KV) cache, is transferred from GPU resource 390 to GPU resource 395 via a fast GPU-to-GPU communication link, such as NVLink. The decode process 380 then operates on GPU resource 395 to process the batch of requests and generate successive tokens in an autoregressive manner.

Although the partially disaggregated execution flow 350 reduces resource contention and allows for independent, parallel, asynchronous operation of the decode process 380, the coupling of the encoding process 360 and prefill process 370 restricts flexibility of resource allocation and configuration. This limitation may lead to latency, suboptimal utilization of resources, reduced batch sizes, and scalability issues, particularly for high-resolution or multi-image tasks.

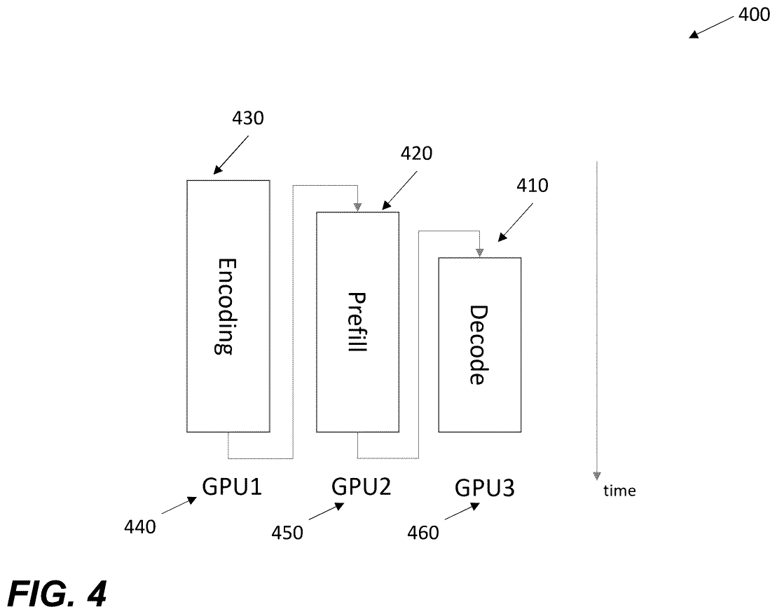

FIG. 4 illustrates a fully disaggregated execution flow 400 of an LMM, in accordance with at least some non-limiting embodiments of the present technology.

In the fully disaggregated execution flow 400, the encoding process 430, prefill process 420, and decode process 410 operate independently on separate GPU resources 440, 450, and 460, respectively. The processor 110 (depicted in FIG. 1) processes inputs including a text prompt iₚ (e.g., text describing the content of an image), multimodal data iₘ (e.g., images or videos), and sampling parameters iₛ (e.g., number of output tokens or temperature settings).

In the encoding process 430 employs an encoder E to transform the multimodal data iₘ into multimodal tokens vₜ, that is, vₜ=E(iₘ). These multimodal tokens vₜ, along with the text prompt iₚ, are then passed to the prefill process 420 for further computation.

In the prefill process 420, a prefill operation P generates a key-value (KV) cache k v₁ and the first output token o₁, represented as k v₁, o₁=P(vₜ, iₚ). The KV cache k v₁ stores context-related information required for decoding, and the token o₁ serves as the starting point for the decoding process.

The KV cache k v₁ and the first output token o₁ are transferred to the decode process 410, where a decoding operation D generates successive output tokens oₜ₊₁ based on the current KV cache k v₁ and previously generated token oₜ. This operation may be expressed as oₜ₊₁=D(k vₜ, oₜ). The process iteratively continues until the desired textual output o is generated in an autoregressive manner.

By fully disaggregating the encoding process 430, prefill process 420, and decode process 410 onto independent GPU resources 440, 450, and 460, the system enables independent resource allocation for each process. This disaggregation allows for optimized batch sizes, higher resolution image processing, and improved scalability, thereby addressing the limitations of monolithic and partially disaggregated systems.

Implementing a fully disaggregated execution flow, as illustrated in FIG. 4, may face several challenges due to the complexities introduced by separating the encoding, prefill, and decode processes.

One challenge may be associated with inter-process communication overhead, where disaggregation may introduce latency due to data transfer between the GPU resources 440, 450, and 460 assigned to the encoding process 430, prefill process 420, and decode process 410, respectively. For example, transferring data between these processes may impact real-time performance metrics such as time-to-first-token (TTFT) and time-per-output-token (TPOT).

Another challenge may be associated with inter-process data transfer, particularly when different parallelization strategies are employed for the encoding, prefill, and decode processes. For instance, if GPU resources 450 and 460 handle the prefill process 420 for a request, but the decode process 410 is assigned to GPU resource 460, the data from GPUs 450 and 460 may need to be transferred and reorganized without introducing additional communication latency.

Furthermore, asynchronous execution of the encoding process 430, prefill process 420, and decode process 410 may introduce complexity, particularly when handling varying workloads, such as data with image-heavy or text-heavy compositions. Additionally, different LMMs may exhibit varying resource requirements across these processes.

Furthermore, automatic process-specific parameter selection may be required for optimizing performance metrics, including TTFT, TPOT, and request throughput (RT). This involves dynamically determining optimal configurations such as batch sizes, scheduling strategies, and parallelization approaches for each of the encoding, prefill, and decoding processes based on workload requirements.

In the subsequent descriptions, example scenarios to which embodiments of the present technology may be applicable are described, along with details on how embodiments of the present technology may address and overcome the challenges outlined above.

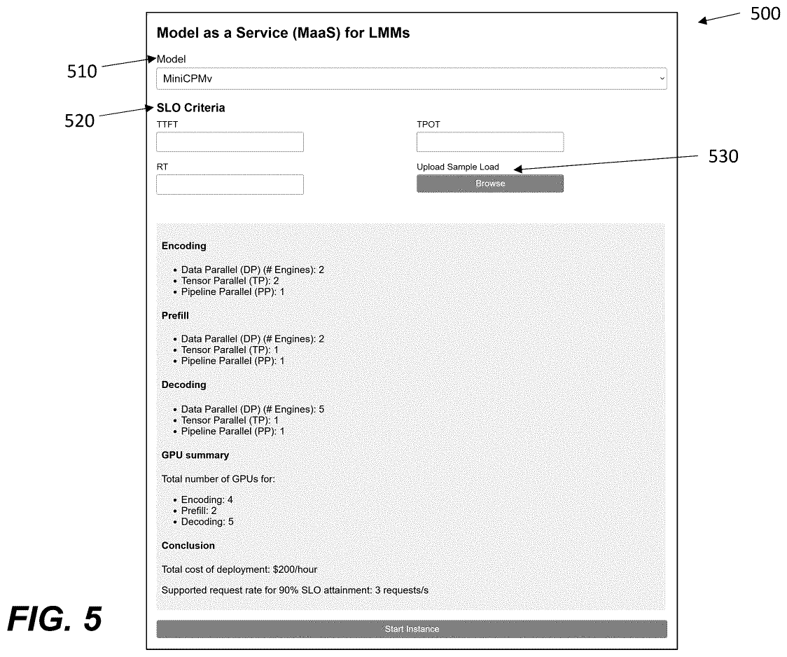

FIG. 5 illustrates an example scenario of a Model as a Service (MaaS) 500 for LMMs, including resource allocation and Service Level Objective (SLO) criteria, in accordance with at least some non-limiting embodiments of the present technology.

In the example MaaS scenario 500, a web service interface may be provided by a system for launching disaggregated LMM instances. The inputs to the service may include a model 510, which specifies the LMM to be served, and Service Level Objective (SLO) criteria 520, which may include one or more of the following performance metrics: (i) time to first token (TTFT), representing the upper time threshold for generating the first output token, (ii) time per output token (TPOT), representing the upper time threshold for generating each successive token, and (iii) request throughput (RT), representing the minimum number of requests the system must process per second. Additionally, a sample load file 530 may be uploaded, which contains representative data for profiling the system's performance and estimating the composition of the expected load.

Based on the provided inputs, the system may determine the resource allocation and deployment characteristics for the encoding, prefill, and decode processes of the LMM. The outputs may include the total number of GPUs allocated for each process (e.g., GPUs for encoding, prefill, and decode stages), the number of GPUs allocated for data parallelization (DP), tensor parallelization (TP), and pipeline parallelization (PP) configurations within each process, the total cost of deployment per hour, and the supported request rate necessary to achieve 90% attainment of the specified SLO criteria.

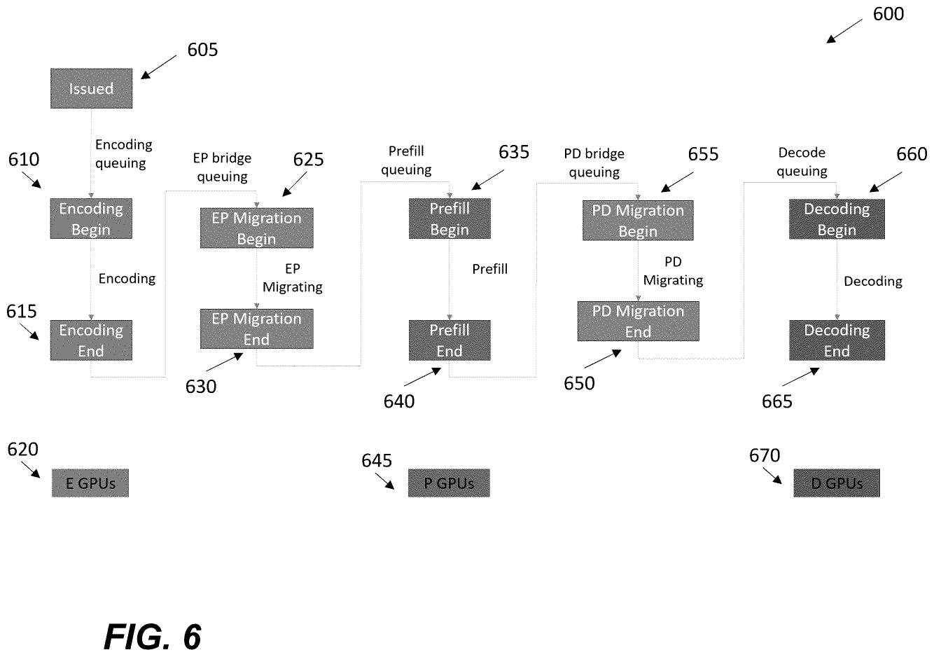

FIG. 6 illustrates a request's data flow 600 in an EPD disaggregated system, in accordance with at least some non-limiting embodiments of the present technology.

In this embodiment, the processor 110 (depicted in FIG. 1) receives one or more multimodal requests, which may include a text prompt, vision data (e.g., images or videos), and sampling parameters. The sampling parameters may include parameters like temperature (indicating randomness in token selection), top_k parameter (specifying the number of top probable tokens to consider during generation), and max_output_tokens parameter (defining the maximum number of tokens to generate).

As shown in FIG. 6, after a multimodal request is issued (indicated by numeral 605), the request is queued by the processor 110 for processing on GPUs 620 allocated for the encoding process. The beginning of the encoding process is indicated by numeral 610 in FIG. 6. The encoding process converts the multimodal request into multimodal tokens. Upon completion of the encoding process, marked by numeral 615, the request and its associated GPU data, including the multimodal tokens, are prepared for transfer to the GPUs 645 allocated for the prefill process. This transfer proceeds through an encode-prefill (EP) bridge queuing phase, during which the request waits to be taken up for migration to the prefill process. The EP migration phase begins once the request is dequeued from the EP bridge queue, indicated by numeral 625, and ends when the data transfer to the prefill GPUs is complete, as marked by numeral 630.

Upon completion of the EP migration phase, the data transferred from the encoding process is queued by the processor 110 for processing on GPUs 645 allocated for the prefill process. The beginning of the prefill process is indicated by numeral 635 in FIG. 6. The prefill process generates a key-value (KV) cache and a first output token. The KV cache stores contextual information necessary for decoding, while the first output token serves as the initial input for the decoding phase.

Upon completion of the prefill process, marked by numeral 640, the request and its associated data generated during the prefill process are prepared for transfer to the GPUs 670 allocated for the decoding process. This transfer proceeds through a prefill-decoding (PD) bridge queuing phase, during which the data waits to be taken up for migration to the decoding process. The PD migration phase begins once the data is dequeued from the PD bridge queue, indicated by numeral 655, and ends when the data transfer to the decoding GPUs is complete, as marked by numeral 650.

The beginning of the decoding process is indicated by numeral 660 in FIG. 6. The decoding process generates successive output tokens in an autoregressive manner using the KV cache and previously generated tokens. The decoding process ends, as indicated by numeral 665, when a complete output response is generated based on the successive output tokens.

Each phase of the data flow 600 may operate asynchronously, independently, and in parallel. Once a request completes the encoding process, it is added to the queue for transfer to the prefill process. Similarly, once a request completes the prefill process, it is added to the queue for transfer to the decoding process. The asynchronous nature of the processes, combined with dedicated GPU resources for encoding, prefill, and decoding processes, may allow the processor 110 to handle multiple requests simultaneously while minimizing contention between the processes.

In some embodiments, the EPD disaggregated system may include a resource allocation module, a bootstrapping module, and an execution module.

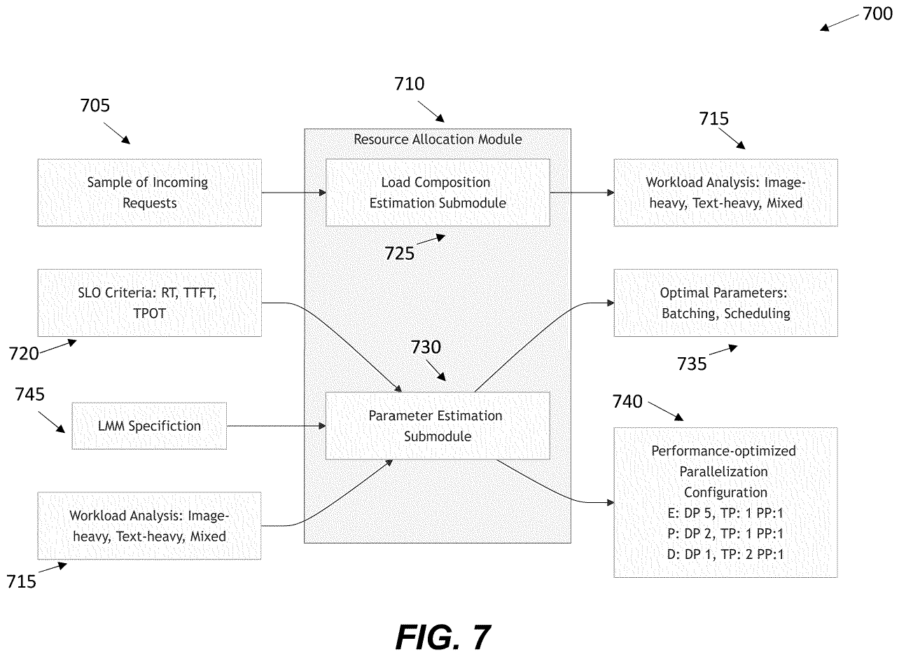

FIG. 7 illustrates a block diagram 700 of the resource allocation module for an EPD disaggregated system, in accordance with at least some non-limiting embodiments of the present technology.

In this embodiment, the resource allocation module 710 includes a load composition estimation submodule 725, a parameter estimation submodule 730, and may be configured by the processor 110 to optimize resource allocation for the disaggregated execution of the encoding, prefill, and decoding processes in an LMM. The resource allocation module 710 may receive inputs such as a sample of incoming requests 705, SLO criteria 720, and specifications of the LMM 745.

The load composition estimation submodule 725 may analyze the sample of incoming requests 705 to extract first-order (mean, median, mode, standard deviation) statistical metrics for different properties of the incoming requests, such as the number of images per request, image resolution, input text length, and output token length. The load composition estimation submodule 725 may use these metrics to profile the workload composition 715 and determine whether the workload is image-heavy, text-heavy, prompt-heavy, generation-heavy, or mixed.

The workload analysis 715 of the load composition estimation submodule 725 may be passed to the parameter estimation submodule 730.

The parameter estimation submodule 730 may include a simulator that utilizes a latency model adapted for EPD disaggregation. The latency model may estimate the execution time for each of the encoding, prefill, and decoding processes by analyzing computational metrics, such as the number of floating-point operations (FLOPs) and memory accesses required for a given workload. The latency model may further incorporate hardware-specific details, such as GPU compute capabilities and memory bandwidth, to approximate the execution times for the respective processes with high accuracy.

The simulator may focus primarily on General Matrix Multiplications (GEMMs), which typically dominate the computational workload in LMMs since memory-bound operations such as Softmax and LayerNorm may be fused with matrix multiplication kernels to enhance efficiency.

The simulator may evaluate multiple parallelism and resource allocation configurations to analyze their impact on key performance metrics, including latency SLO attainment. The SLO criteria may include, for example, time-to-first-token (TTFT), time-per-output-token (TPOT), and request throughput (RT). The simulator may simulate the execution of inference processes under varying workload conditions and estimate performance metrics such as execution time, throughput, and resource utilization for the encoding, prefill, and decoding processes.

By iterating over a range of resource allocation and parallelization strategies, the simulator may identify optimized configurations that minimize latency, maximize throughput, and ensure adherence to specified SLO requirements.

The parameter estimation submodule 730 may evaluate the computational and memory requirements of the encoding, prefill, and decoding stages based on the workload composition 715, LMM specification 745, and SLO criteria 720. For instance, for vision-heavy workloads, the parameter estimation submodule 730 may allocate more resources to the encoding process, whereas for generation-heavy workloads, the parameter estimation submodule 730 may allocate more resources to the decoding process.

The LMM specification 745 used by the parameter estimation submodule 730 may include the LMM's architectural details, such as the multimedia encoder structure (e.g., vision tower), backbone LLM, KV cache design (e.g., the number of attention heads), and image patching strategies. These details may influence the computational complexity and resource demands for each process.

The SLO criteria 720, such as TTFT, TPOT, and RT, may be used by the parameter estimation submodule 730 for the optimization of batching, scheduling, and parallelization parameters, as indicated by numeral 735. SLOs define acceptable thresholds for metrics such as RT, TTFT, and TPOT. For example, some embodiments, such as chatbots, may prioritize low TTFT (e.g., TTFT<1 s) to generate fast responses, while some other embodiments, such as document summarization applications, may focus on minimizing TPOT (e.g., TPOT<0.2 s) due to their longer input lengths. Some other embodiments, such as offline applications, may disregard per-request metrics like TTFT or TPOT in favor of broader service-level criteria, such as achieving a specific throughput (e.g., RT>20 requests/s).

The parameter estimation submodule 730 may also generate a performance-optimized parallelization configuration 740 for the encoding, prefill, and decoding processes. These configurations may include optimum data parallelization (DP), tensor parallelization (TP), and pipeline parallelization (PP) strategies.

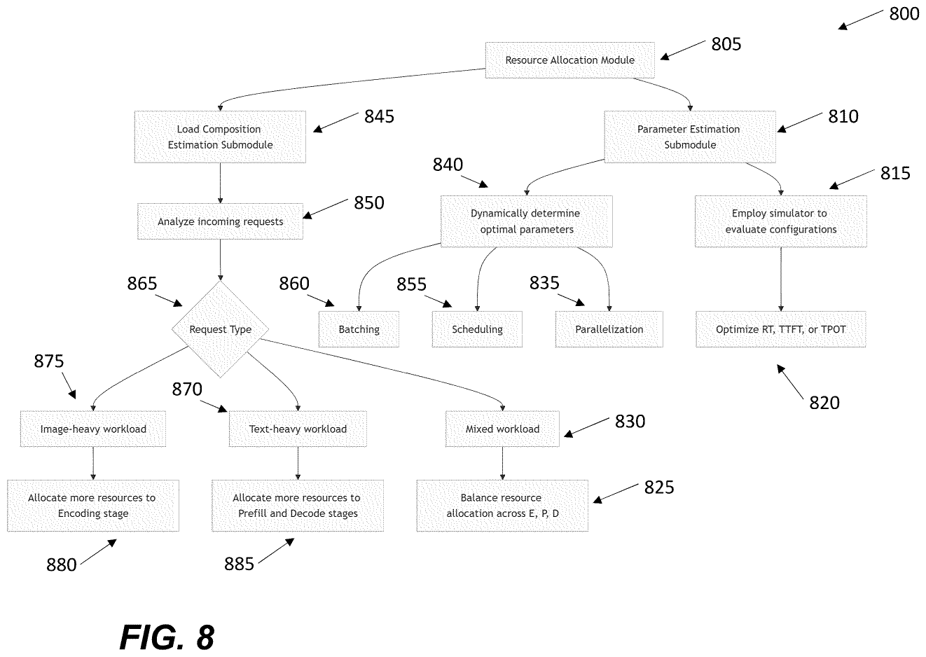

FIG. 8 illustrates the workflow and decision-making processes 800 of the resource allocation module for an EPD disaggregated system, in accordance with at least some non-limiting embodiments of the present technology.

In this embodiment, the load composition estimation submodule 845 of the resource allocation module 805 may analyze the incoming requests (as indicated by numeral 850), and determine workload characteristics through a decision-making process 865. The workload characteristics may indicate whether the workload is image-heavy 875, text-heavy 870, or mixed 830. The analysis of incoming requests enables the resource allocation module 805 to allocate resources dynamically based on the type of workload. For instance, for image-heavy workloads 875, the resource allocation module 805 may allocate more resources for the encoding process, as indicated by numeral 880. Similarly, for text-heavy workloads 870, more resources may be allocated to the prefill and decoding stages, as indicated by numeral 885. Similarly, for mixed workloads 830, resources may be balanced among the encoding, prefill and decoding processes, as indicated by numeral 825.

Furthermore, the parameter estimation submodule 810 of the resource allocation module 805 may determine optimal configurations, such as strategies for batching 860, scheduling 855, and parallelization 835, based on the workload characteristics and SLO criteria.

Additionally, the parameter estimation submodule 810 may employ a simulator 815 to evaluate various resource allocation configurations under simulated conditions. The simulator may estimate execution times, throughput, and resource utilization for different parallelization and scheduling strategies. The simulator may also evaluate different configurations against performance metrics, such as TTFT, TPOT, and RT, to optimize system performance, as indicated by numeral 820.

The outputs generated by the resource allocation module 710 (with reference to FIG. 7) or 805 (with reference to FIG. 8), including optimized configurations for resource allocation, may be provided as inputs to a bootstrapping module.

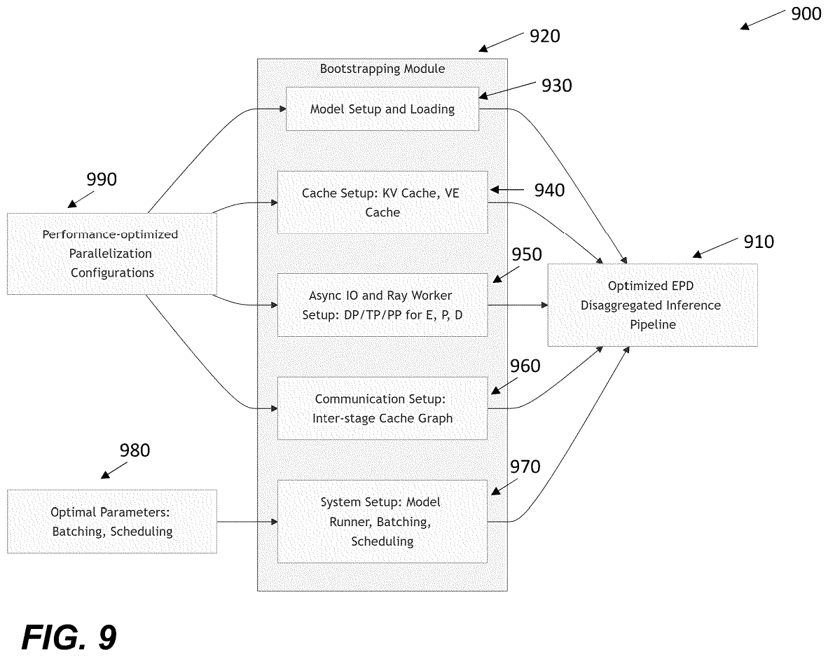

FIG. 9 illustrates a block diagram of the bootstrapping module for an EPD disaggregated system, in accordance with at least some non-limiting embodiments of the present technology.

In this embodiment, the bootstrapping module 920 may be configured by the processor 110 to receive performance-optimized configurations 990 as inputs. These configurations are determined by the resource allocation module, as described with reference to FIG. 7 and FIG. 8, and may include parallelization, batching, and scheduling strategies. Based on the received configurations, the bootstrapping module 920 may set up the system for disaggregated execution across the encoding, prefill, and decoding processes. The bootstrapping module 920 may include several submodules, as described below.

The model setup and loading submodule 930 may initialize the LLM backbone and vision tower based on the parallelization configuration, which may include data parallelism (DP), tensor parallelism (TP), or pipeline parallelism (PP). The model setup and loading submodule 930 may determine the optimal distribution of GPUs across the encoding, prefill, and decoding stages, assigning portions of the model to each GPU as appropriate. Once the parallelization configuration is established, the trained model checkpoints may be loaded in parallel onto the GPUs allocated for each stage.

The cache setup submodule 940 may initialize portions of the KV cache for the prefill and decoding stages based on the GPU distribution strategy. In addition, the cache setup submodule 940 may initialize a VE cache, which may store vision tokens generated during the encoding process and may be allocated on GPUs designated for the encoding stage and the prefill stage. The cache setup submodule 940 may also initialize a KV cache on the GPUs associated with the prefill and decode stages.

The async IO and ray worker setup submodule 950 may configure an asynchronous infrastructure to facilitate non-blocking operations across the encoding, prefill, and decoding stages. To achieve non-blocking operations, the async IO framework may be utilized, where separate and independent non-blocking event loops may be established for each of the encoding, prefill, and decoding processes. Within each process, independent ray workers may be initialized as separate CPU processes corresponding to each GPU. These ray workers may execute tasks independently on associated GPUs and communicate the results with a master or driver process through inter-process communication (IPC), allowing parallel execution of GPU operations. By isolating GPU operations through independent processes, the async IO and Ray worker setup submodule 950 may prevent resource contention and maintain high concurrency across the system.

The communication setup submodule 960 may establish communication pathways between GPUs across different processes to facilitate data transfer. For instance, GPUs executing a downstream stage (e.g., prefill GPUs) may need to access data generated during an upstream stage (e.g., encoding GPUs). To enable this, the communication setup submodule 960 may configure a memory graph, ensuring that GPUs have direct access to the addresses of caches, such as the KV cache or VE cache, of the previous stage. Once the memory graph is established, GPUs may directly request specific cache data, such as certain VE cache blocks, from the upstream GPUs without CPU mediation. For example, if the prefill process is executed on GPUs #2 and #3 while the decode process is assigned to GPU #4, the communication setup submodule 960 may enable transfer of KV cache and intermediate data from GPUs #2 and #3 directly to GPU #4, minimizing communication overhead and enabling high-speed, low-latency GPU-to-GPU data transfer.

The system setup submodule 970 may perform additional configuration tasks required for the operation of the EPD disaggregated system. These tasks may include setting up a scheduler that implements the required batching strategies, scheduling mechanisms, and other object abstractions. The system setup submodule 970 may create components such as a model runner, block manager, and scheduler to manage the execution flow such that the inference tasks are executed with optimal performance and resource utilization.

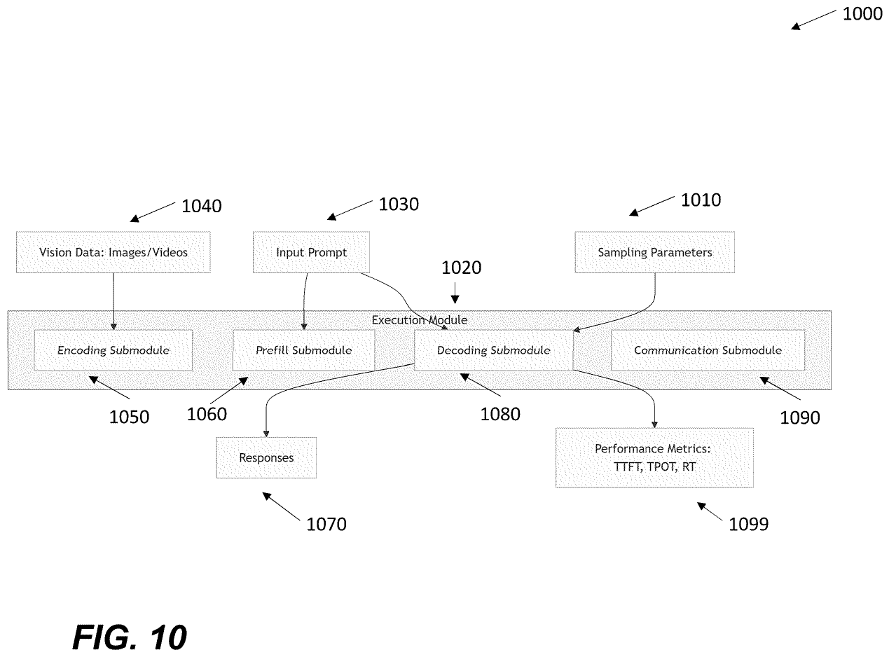

FIG. 10 illustrates a block diagram 1000 of the execution module for an EPD disaggregated system, in accordance with at least some non-limiting embodiments of the present technology.

In this embodiment, the execution module 1020 may be configured by the processor 110 to manage execution of multimodal requests across the encoding, prefill, and decoding processes. The execution module 1020 may include an encoding submodule 1050, a prefill submodule 1060, a decoding submodule 1080, and a communication submodule 1090. These submodules may operate in coordination to enable independent, parallel, asynchronous processing of incoming requests.

The execution module 1020 may receive inputs such as sampling parameters 1010, input prompts 1030, and vision data 1040 (e.g., images or videos) and may generate finalized responses 1070 as output. Performance metrics 1099, such as TTFT, TPOT, and RT, may be monitored by the execution module 1020 to evaluate system performance.

The encoding submodule 1050 may process vision data to generate vision tokens. The prefill submodule 1060 may combine the vision tokens with input text embeddings to generate an initial token and KV cache data. The decoding submodule 1080 may generate successive output tokens in an autoregressive manner until a predefined token limit or an end-of-sequence (EOS) token is reached. The communication submodule 1090 may facilitate inter-stage data transfers across GPUs by enabling direct access to cache data stored in preceding stages.

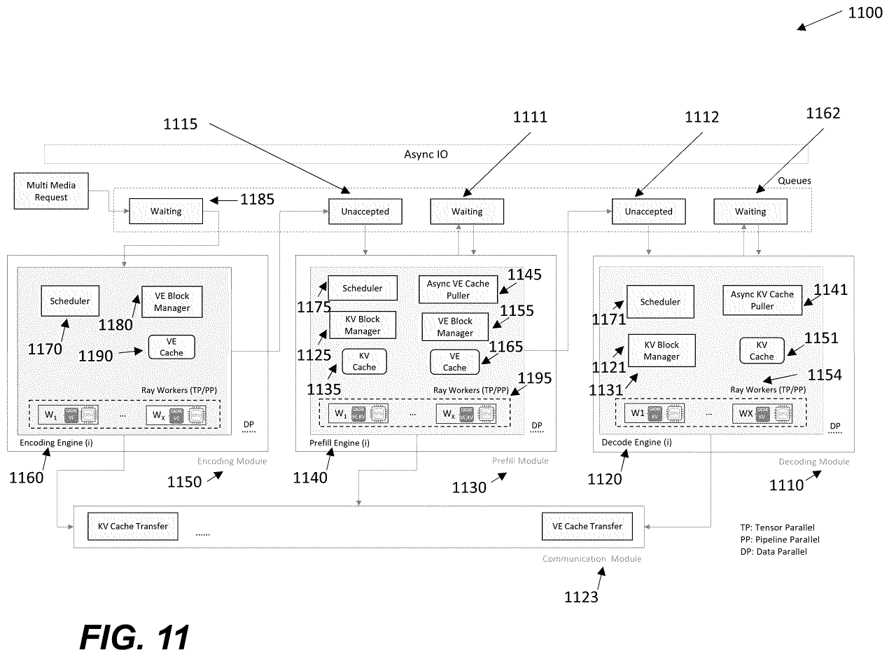

FIG. 11 illustrates the architecture 1100 of the execution module for an EPD disaggregated system, in accordance with at least some non-limiting embodiments of the present technology.

In this embodiment, the execution module 1100 may manage the independent, parallel, asynchronous execution of the encoding, prefill, and decoding processes using dedicated schedulers, cache managers, and worker processes.

The execution module 1100 may include an encoding submodule 1150, a prefill submodule 1130, and a decoding submodule 1110.

The encoding submodule 1150 may include one or more encoding engines 1160, scheduler 1170, VE block manager 1180, VE cache 1190, and ray workers 1195.

The scheduler 1170 may select a batch of requests from a waiting queue 1185 and assigns them to an encoding engine. The encoding engine may process the vision data (e.g., images or videos) in the requests by applying a patching strategy to segment an image into patches. The patched data may then be processed using a vision transformer (e.g., Contrastive Language-Image Pre-training (CLIP), Sigmoid Loss for Language Image Pre-Training (SIGLIP)) to generate vision embeddings, which may be projected into vision tokens using a projector such as a multi-layer perceptron (MLP) or a resampler. For each request, the VE Block Manager 1180 may allocate slots in the VE cache 1190 to store the vision tokens generated by the encoding engine. Once the encoding process is complete, the request may be moved to the unaccepted queue 1115 of the prefill module 1130, indicating readiness for transfer.

In the prefill submodule 1130, a scheduler 1175 may monitor the unaccepted queue 1115 for requests awaiting transfer. If such a request is found, the scheduler 1175 may assign the request to one of the prefill engines 1140. Furthermore, the vision tokens from the VE cache 1190 of the encoding submodule 1150 may be transferred to the GPUs assigned to the prefill stage using an async VE cache puller 1145. The tokens from the VE cache 1190 of the encoding submodule may be transferred to VE cache 1165 of the prefill submodule via NVLink, avoiding CPU mediation and minimizing latency. For this transfer, the prefill submodule 1130 may allocate new blocks in the VE cache 1165 of the prefill submodule using the VE Block Manager 1155. Then, the transfer may be performed block-by-block in an asynchronous mode. Further, this transfer may be performed based on the placement strategy of the encoding and prefill submodules and the vision tokens may be directly moved from the GPUs in the encoding submodule to the corresponding GPUs in prefill submodule that are assigned for a particular request. Once the transfer is complete, the requests may be added to the waiting queue 1111 of the prefill submodule, and the associated data may be removed from the VE Cache 1190 of the encoding submodule.

The prefill scheduler 1175 may then select a batch of requests from the waiting queue 1111 based on the scheduling and batching strategy of the assigned prefill engine 1140. For each request, slots in the KV Cache 1135 of the prefill submodule may be allocated by the prefill submodule, proportional to the combined length of the vision and text tokens, using the KV Block Manager 1125. The vision tokens may be retrieved from the VE Cache 1165 of the prefill submodule, and combined with the text embeddings to execute the prefill process using one of more ray workers 1195, depending on the tension parallel (TP)/pipeline parallel (PP) strategy of the prefill engine 1140. The output of this combination includes the first output token and the KV Cache data, which may be directly written to the KV Cache by the underlying kernel. Once the prefill module's operations are complete, the request may be added to the unaccepted queue 1112 of decoding submodule 1110, awaiting transfer to the decoding submodule 1110.

In the decoding submodule 1110, a scheduler 1171 may monitor the unaccepted queue 1112 for requests awaiting transfer. If such a request is found, the scheduler 1171 may assign the request to one of the decoding engines 1120. Next, for each request, slots in the KV Cache 1151 of the decoding submodule may be allocated using a KV Block Manager 1121. Next, the scheduler 1171 may use Async KV Cache Puller 1141 to initiate direct GPU-to-GPU data transfer via NVLink to move KV Cache data of the corresponding request from the prefill submodule 1130 to the decoding submodule 1110. Depending on the parallelism configuration (e.g., tensor parallelism or pipeline parallelism), only the required portions of the KV Cache may be transferred between corresponding GPUs of prefill and decoding submodules. After the transfer is complete, requests may be added to the waiting queue 1162 of the decoding submodule, and the associated data may be removed from the KV Cache 1135 of the prefill submodule.

Next, the decoding scheduler 1171 may select a batch of requests from the waiting queue 1162 and integrate them into the running batch of requests using a continuous batching feature. Using the KV Cache data, the decoding submodule 1110 may perform the decoding operation using one or more ray workers 1154 to generate successive tokens in an autoregressive manner. This process may continue until the EOS token is reached or the maximum token limit for the request is reached. Once decoding is complete, the generated response may be transferred to the processor 110.

The communication submodule 1123 may facilitate data transfer between GPUs across the encoding, prefill, and decoding submodules, by constructing and maintaining a memory graph of cache addresses. The memory graph may allow GPUs in downstream stages to directly access data from preceding stages. For example, KV cache data generated in the prefill stage may be transferred using NVLink to decoding GPUs based on the memory graph, with minimal latency, avoiding redundant communication and reducing overhead.

It is contemplated that each operation in the encoding, prefill, decoding, and inter-stage data transfer processes may be executed independently, asynchronously and in parallel to maximize system throughput. It is further contemplated that such non-blocking execution may prevent any submodule from waiting for another submodule to complete, thereby allowing the processor 110 to handle requests concurrently and achieve optimal performance.

In some embodiments of the present technology, additional optimizations may be applied to the EPD disaggregated system.

For instance, in some embodiments of the present technology, intra-request data parallelism for encoding may be implemented in the encoding stage. That is, the multimodal data (e.g., images, videos, or audio data) within a single request may be processed independently and in parallel across multiple GPUs operating in a data parallel (DP) mode. Since the multimodal components within a request are inherently independent, they may be processed on separate GPUs assigned to the encoding stage. It is contemplated that this parallelization may significantly reduce the TTFT metric. It is also contemplated that the disaggregated architecture of some embodiments of the present technology may naturally extend support for such intra-request data parallelism in the encoding phase.

Furthermore, in some embodiments of the present technology, the encoding and prefill processes may be executed on separate node types in a heterogeneous system to optimize resource utilization. For example, the computational and memory requirements of the encoding and prefill stages may differ depending on the characteristics of the LMM and the load composition. The encoding stage may be compute-bound, while the prefill and decode stage may be memory-bound for certain workloads. Based on such distinctions, compute-specific GPUs may be allocated for the encoding stage, while memory-specific GPUs may be allocated for the prefill stage in a heterogeneous GPU system.

Furthermore, in some embodiments of the present technology, the encoding stage may only need to be executed by small transformers requiring lesser number of parameters compared to an LLM which is required for prefill and decode stages. Therefore, the encoding stage in some embodiments may be assigned to low end GPUs that have lesser memory, and prefill and decode stages may be assigned to higher end GPUs having more memory. The ability to allocate resources based on the specific needs of each phase may be achievable in a disaggregated system where encoding and prefill processes operate independently.

Furthermore, in some embodiments of the present technology, the sharing of encoder GPUs across various LMMs may be implemented. In some LMMs, the encoder may have significantly fewer parameters compared to the LLM. For example, an LMM encoder may have 400 million parameters, whereas the LLM may have 7 billion parameters. In such cases, the GPUs assigned to the encoding stage may be capable of simultaneously hosting encoders for multiple LMMs, allowing for resource sharing across various models. It is contemplated that this resource-sharing capability may not be achievable in monolithic systems where all inference processed are coupled together.

Furthermore, in some embodiments of the present technology, the execution module 1100 may be extended to support additional modalities beyond vision data, such as audio data, or a combination of multiple modalities (e.g., audio-visual data).

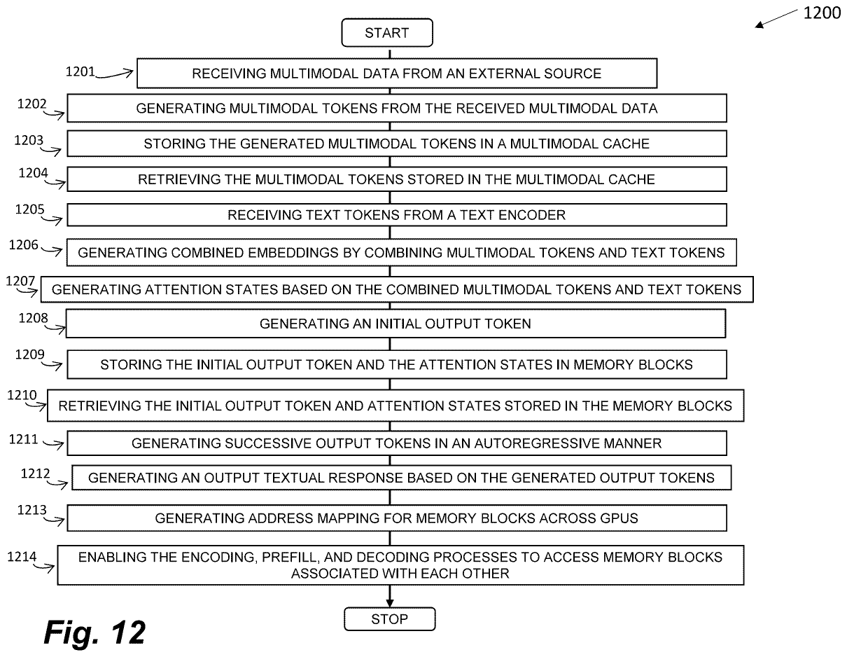

In some embodiments of the present technology, the processor 110 is configured to execute a method 1200 for processing multimodal data using an LMM. A scheme-block illustration of the operations of the method 1200 is depicted in FIG. 12. In one or more aspects, the method 1200 or one or more steps thereof may be performed by the processor 110 of the computer system 100. The method 1200 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1200 starts with receiving, at operation 1201, multimodal data from an external source. For example, in some embodiments, the processor 110 may be configured to receive textual data, images, 3D scenes etc. from a user or from another system.

The method 1200 continues with generating, at operation 1202, multimodal tokens from the received multimodal data.

The method 1200 continues with storing, at operation 1203, the generated multimodal tokens in a multimodal cache.

The method 1200 continues with retrieving, at operation 1204, the multimodal tokens stored in the multimodal cache.

The method 1200 continues with receiving, at operation 1205, text tokens from a text encoder.

The method 1200 continues with generating, at operation 1206, combined embeddings by combining the retrieved multimodal tokens and the received text tokens.

The method 1200 continues with generating, at operation 1207, attention states based on the combined multimodal tokens and text tokens.

The method 1200 continues with generating, at operation 1208, an initial output token.

The method 1200 continues with storing, at operation 1209, the initial output token and the attention states in memory blocks.

The method 1200 continues with retrieving, at operation 1210, the initial output token and attention states stored in the memory blocks.

The method 1200 continues with generating, at operation 1211, successive output tokens in an autoregressive manner based on the retrieved initial output tokens and the retrieved attention states

The method 1200 continues with generating, at operation 1212, an output textual response based on the generated output tokens

The method 1200 continues with generating, at operation 1213, an address mapping for memory blocks across graphics processing units associated with the encoding process, the prefill process, and the decoding process.

The method 1200 continues with enabling, at operation 1214, the encoding process, the prefill process, and the decoding process to access memory blocks associated with each other to support data transfer between the encoding process, the prefill process, and the decoding process.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 1000 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for processing multimodal data using a Large Multimedia Model (LMM), the method comprising:
an encoding process including:
receiving multimodal data from an external source,
generating multimodal tokens from the received multimodal data, and
storing the generated multimodal tokens in a multimodal cache,
a prefill process including:
retrieving the multimodal tokens stored in the multimodal cache,
receiving text tokens from a text encoder,
generating combined embeddings by combining the retrieved multimodal tokens and the received text tokens,
generating attention states based on the combined multimodal tokens and text tokens,
generating an initial output token, and
storing the initial output token and the attention states in memory blocks,
a decoding process including:
retrieving the initial output token and attention states stored in the memory blocks,
generating successive output tokens in an autoregressive manner based on the
retrieved initial output tokens and the retrieved attention states, and
generating an output textual response based on the generated output tokens,
a communication process including:
generating an address mapping for memory blocks across graphics processing units associated with the encoding process, the prefill process, and the decoding process, and
enabling the encoding process, the prefill process, and the decoding process to access memory blocks associated with each other to support data transfer between the encoding process, the prefill process, and the decoding process,
wherein the encoding process, the prefill process, and the decoding process operate independently during the processing of the multimodal data.

2. The method of claim 1, wherein the encoding process, the prefill process, and the decoding process form an executing module of the method.

3. The method of claim 1, wherein the encoding process, the prefill process, and the decoding process operate in parallel.

4. The method of claim 1, wherein the encoding process, the prefill process, and the decoding process operate asynchronously.

5. The method of claim 1, wherein the independent operation of the encoding process, the prefill process, and the decoding process includes independent optimal batching, parallelization, scheduling, and resource allocation.

6. The method of claim 1, wherein the memory blocks used for storing the initial output token belong to a local central processing unit.

7. The method of claim 1, wherein the memory blocks used for storing the attention states belong to a key-value cache of a graphics processing unit.

8. The method of claim 1, wherein the encoding process, the prefill process, and the decoding process operate on a single physical system.

9. The method of claim 1, wherein the encoding process, the prefill process, and the decoding process operate on separate servers connected over a network.

10. The method of claim 1, wherein the external source is a user or a system providing multimodal data for processing.

11. The method of claim 1, wherein the attention states include keys and values, derived by a multi-head attention mechanism in transformer architectures, the keys representing linear projections of input embeddings indicative of contextual relationships, and the values representing corresponding projections that encode content information used by the multi-head attention mechanism.

12. The method of claim 1, further comprising a resource allocation process including:
receiving sample multimodal data comprising at least one of textual data and visual data from an external source,
receiving at least one service level objective from an external source,
determining a modality composition of the received sample multimodal data,
determining computational characteristics of the LMM, and
determining at least one of resource allocation parameters, batching parameters, scheduling parameters, and parallelization parameters for the encoding process, the prefill process, and the decoding process based on the determined modality composition, the determined computational characteristics, and the at least one service level objective.

13. The method of claim 1, further comprising a bootstrapping process including:
receiving at least one resource allocation parameter, at least one parallelization parameter,
at least one batching parameter, and at least one scheduling parameter associated with the encoding process, the prefill process, and the decoding process,
initializing the encoding process, the prefill process, and the decoding process based on the received parameters,
allocating memory blocks for storing data temporarily, the data including multimodal tokens, text tokens, initial output token, and attention states, and
establishing communication pathways between the encoding process, the prefill process, and the decoding process for transferring data between them.

14. The method of claim 12, wherein the external source is a user or a system providing multimodal data for processing.

15. The method of claim 12, wherein the modality composition of the received sample multimodal data is indicative of the received sample multimodal data being image-heavy, text-heavy, or mixed.

16. The method of claim 12, wherein the computational characteristics of the LMM are indicative of the LMM being Large Language Model (LLM)-heavy or non-textual heavy.

17. The method of claim 12, wherein determining the resource allocation parameters includes determining:
assignments of graphics processing units for the encoding process, the prefill process, and the decoding process,
memory block allocation sizes for caches used by the encoding process, the prefill process, and the decoding process, and
batching sizes, scheduling strategies, and parallelization strategies for the encoding process, the prefill process, and the decoding process.

18. The method of claim 12, wherein the at least one service level objective includes:
a minimum request throughput,
a maximum allowable time to first output token, and
a maximum allowable time per output token.

19. The method of claim 13, wherein the memory blocks include:
a multimodal cache for storing multimodal tokens generated by the encoding process, memory blocks on a central processing unit (CPU) for storing the initial output token, and
a key-value cache for storing the attention states generated by the prefill process.

20. An electronic device comprising a non-transitory computer-readable medium and a processor, the non-transitory computer-readable medium comprising instructions, which upon being executed by the processor, configure the processor to execute:
an encoding process including:
receiving multimodal data from an external source,
generating multimodal tokens from the received multimodal data, and
storing the generated multimodal tokens in a multimodal cache,
a prefill process including:
retrieving the multimodal tokens stored in the multimodal cache,
receiving text tokens from a text encoder,
generating combined embeddings by combining the retrieved multimodal tokens and the received text tokens,
generating attention states based on the combined multimodal tokens and text tokens,
generating an initial output token, and
storing the initial output token and the attention states in memory blocks,
a decoding process including:
retrieving the initial output token and attention states stored in the memory blocks,
generating successive output tokens in an autoregressive manner based on the retrieved initial output tokens and the retrieved attention states, and
generating an output textual response based on the generated output tokens,
a communication process including:
generating an address mapping for memory blocks across graphics processing units associated with the encoding process, the prefill process, and the decoding process, and
enabling the encoding process, the prefill process, and the decoding process to access memory blocks associated with each other to support data transfer between the encoding process, the prefill process, and the decoding process,
wherein the encoding process, the prefill process, and the decoding process operate independently during the processing of the multimodal data.
